(19) United States
(12) Patent Application Publication
(10) Pub. No.: US 2012/0299994 A1
(43) Pub. Date: Nov. 29, 2012

(54) INK JET PRINTER WIPER BLADE

(75) Inventor: YUAN-CHAN HSU, Tu-Cheng (TW)

(73) Assignee: HON HAI PRECISION INDUSTRY CO., LTD., Tu-Cheng (TW)

(21) Appl. No.: 13/187,463

(22) Filed: Jul. 20, 2011

(30) Foreign Application Priority Data
May 26, 2011 (TW) 100118528

(51) Int. Cl. B41J 2/165

(52) U.S. Cl. 347/33

(57) ABSTRACT

An ink jet printer wiper blade includes a base, and a blade plate extending from the base. The blade plate includes a support portion and a lead edge portion proximate to the support portion, the lead edge portion is configured for scraping waste ink. The blade plate comprises a plurality of elongate protrusions protruding from the support portion. The protrusions are configured for creating a Coanda effect to attract the scraped ink to the support portion.

### BACKGROUND

1. Technical Field

The present disclosure relates to an ink jet printer wiper blade.

2. Description of Related Art

The wiper blade is an important component for cleaning a print head of an ink jet printer. The wiper blade is made of elastic rubber, and tends to eject the scraped ink out when on the rebound action, which may contaminate the surrounding components.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a wiper blade utilized in an ink jet printer in accordance with one embodiment.

FIG. 2 is a schematic view showing that the wiper blade of FIG. 1 is bent when scraping ink off a print head.

### DETAILED DESCRIPTION

Embodiments of the present disclosure will now be described in detail below, with reference to the accompanying drawings.

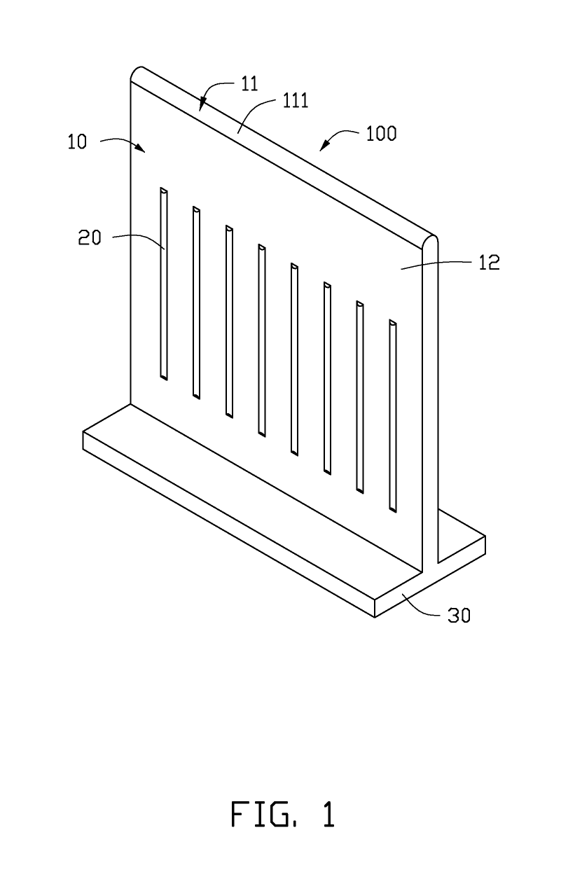

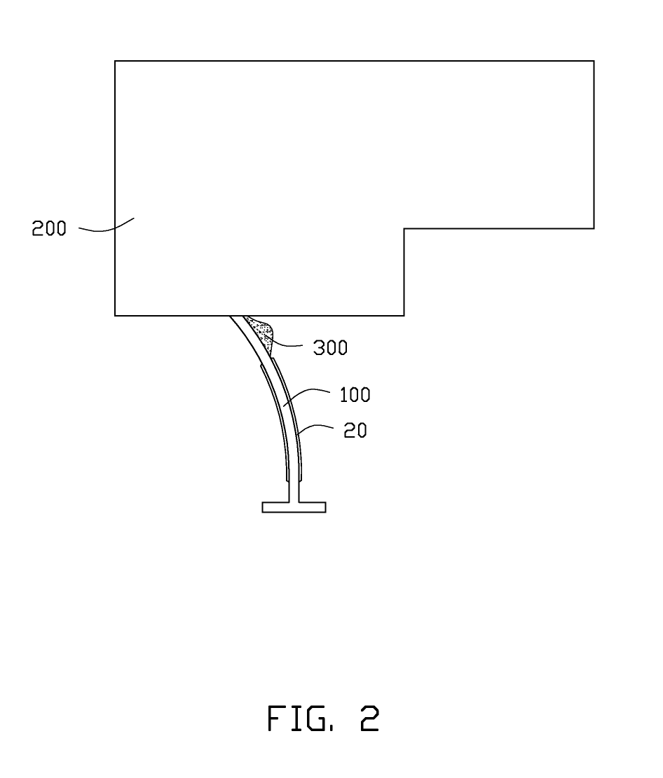

Referring to FIGS. 1 and 2, a wiper blade 100 for an ink jet printer is provided. The wiper blade 100 includes a blade plate 10 and a base 30. The blade plate 10 extends from the base 30, the blade plate 10 includes a support portion 12 and a lead edge portion 11 proximate to the support portion 12, the lead edge portion 11 is moved to scrape waste ink 300 off a print head 200 and is formed on the support portion 12. In the embodiment, the blade plate 10 is a rectangular elastic sheet.

The blade plate 10 includes a number of elongate protrusions 20 protruding from opposite sides of the support portion 12. In this embodiment, the lead edge portion 11 includes a scraping edge 111, the elongate protrusions 20 are substantially perpendicular to the scraping edge 111. The elongate protrusions 20 are evenly spaced apart from each other. The elongate protrusions 20 can enhance the bending strength of the blade plate 10. In an alternative embodiment, the elongate protrusions 20 may protrude from both sides of the blade plate 10 and may be set to be inclined with respect to the lead edge portion 11.

The base 30 may be mounted on a driving device (not shown). The driving device is used to drive the blade plate 10 to move, such that the lead edge portion 11 abutting against the print head 200 can move to scrape the remaining ink 300 on the print head 200. The blade plate 10 can be made of rubber, plastic, or any suitable flexible and corrosion-resistant material.

The Coanda effect is the tendency of a fluid jet to be attracted to a nearby surface. In a process of scraping off the waste ink 300 on the print head 200, the waste ink 300 will be attracted to the elongate protrusions 20 and flow along the protrusions 20 to the bottom of the blade plate 10, so the contamination caused by the scraped ink 300 when the wiper blade 100 rebounds may be reduced or eliminated.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An ink jet printer wiper blade comprising:
a base; and
a blade plate extending from the base, the blade plate including a support portion and a lead edge portion proximate to the support portion, the lead edge portion configured for scraping waste ink, the blade plate comprising a plurality of elongate protrusions protruding from the support portion, the protrusions configured for creating a Coanda effect to attract the scraped ink to the support portion.

2. The wiper blade utilized in an ink jet printer according to claim 1, wherein the blade plate is made of rubber or plastic.

3. The wiper blade utilized in an ink jet printer according to claim 1, wherein the lead edge portion includes a scraping edge, the elongate protrusions are substantially perpendicular to the scraping edge.

4. The wiper blade utilized in an ink jet printer according to claim 1, wherein the elongate protrusions are formed on opposite sides of the support portion.

5. The wiper blade utilized in an ink jet printer according to claim 1, wherein the lead edge portion is formed on the support portion and is moved to scrape waste ink off a print head.
